(19) United States
(12) Patent Application Publication
(10) Pub. No.: US 2026/0028944 A1
(43) Pub. Date: Jan. 29, 2026

(54) METHOD FOR SYNCHRONIZING A COMBUSTION ENGINE USING A CAMSHAFT TARGET

(71) Applicant: Schaeffler Technologies AG & Co. KG, Herzogenaurach (DE)

(72) Inventors: Stéphane ELOY, Toulouse (FR); Fabien JOSEPH, Toulouse (FR)

(21) Appl. No.: 19/219,216

(22) Filed: May 27, 2025

(30) Foreign Application Priority Data
Jul. 24, 2024 (FR) 2408148

(51) Int. Cl. F02D 41/00; F01L 1/46; G01D 5/245

(52) U.S. Cl. CPC F02D 41/009; F01L 1/46; G01D 5/2451

(57) ABSTRACT

The invention relates to a method for determining the angular position of an unevenly toothed camshaft target. A sensor generates a signal upon each passage of the teeth, creating significant edges. A computing unit processes this signal in order to determine the time intervals between these edges, as well as to store theoretical ratios, tolerance intervals, and confidence intervals. Suspicion meters are associated with each edge. By computing real ratios based on the measured intervals, the unit discriminates the candidate edges: the edges that do not correspond to the tolerances are removed, those corresponding to the confidence intervals reset the suspicion meter, and those outside the confidence intervals increase the suspicion meter until they are removed. The steps are repeated until a single candidate edge is identified. The angular position of the target is then determined based on this single edge.

### FIELD OF THE INVENTION

The present invention relates to an improved method for synchronizing a combustion engine using a camshaft target.

### PRIOR ART

An internal combustion engine must be phased, or synchronized, in order to determine and optimize the best time to burn the fuel in the cylinder, i.e., to optimize fuel consumption in particular.

Throughout this document, synchronization means determining the angular position of the internal combustion engine during the combustion cycle.

The cycle of an internal combustion engine includes several phases, which are staggered over time for each cylinder, with the synchronized control of the valves of the combustion engine being achieved by the camshaft.

In order for the combustion cycle to proceed normally, a reliable angular reference needs to be available that is used as the basis for determining each phase of each cylinder.

The camshaft is set into rotation by the crankshaft. The crankshaft is a mechanical device that allows, by means of a connecting rod, the straight movement of a piston to be converted into a continuous rotational movement, and vice versa, thus converting the combustion energy of the fuel in the cylinders into mechanical energy.

Thus, knowing the angular position of the crankshaft provides a reliable angular reference that is used as the basis for determining each phase of each cylinder.

Such a reference is available via a toothed wheel, also called target, that is rotationally integral with the crankshaft. The wheel is associated with a dedicated sensor, called crankshaft sensor, the ultimate purpose of which is to allow the angular position and the rotation speed of the toothed wheel to be determined. The sensor is equipped with a sensitive element. According to one example, the wheel is metal and the sensitive element, such as a Hall effect sensor, is able to detect metal. The profile of the wheel typically includes a target provided with markings, also called teeth, distributed around its periphery. The function of the crankshaft sensor is to convert the measured magnetic field into an electrical signal. According to the prior art, some sensors are connected to the control unit by three wires (ground, power supply and signal) and are able to determine the direction of rotation of a crankshaft target. The passage of a tooth of the toothed wheel associated with the crankshaft generates an electrical pulse on the signal wire. The predetermined duration represents the direction of rotation (typically 45 μs for a forward rotation and 90 μs for a reverse rotation). The crankshaft sensor is typically mounted in the vicinity of the engine flywheel, which acts as a rotating target wheel or supports such a target.

The rotating target has a signature, also called long tooth or gap, formed by a singularity in the profile (which is otherwise even) that usually corresponds to two missing markers, and that allows a reference to be defined for the position of the crankshaft. Such a signature generates a different signal from the other markers, for determining when the rotating target wheel has made a complete rotation.

A commonly employed rotating target comprises 60 markers distributed over the periphery of the rotating target, and two consecutive markers that are removed to create the signature. Such a target is called a 60-2 rotating target. Another known rotating target is the 36-2 rotating target (34 markers plus two missing markers).

The rotation of the rotating target causes periodic modifications in the magnetic flux that are due to the passage of the markers, with these modifications being converted by the sensor into voltage variations that then can be sent to the engine management computer. The voltage variations include rising edges and falling edges forming a periodic signal that is synchronized with the passage of the markers in front of the sensor.

During one rotation of the engine, the crankshaft rotates twice, whereas the camshafts rotate only once.

Additional information is therefore obtained using the camshaft sensor. The camshaft sensor interacts, in a manner known per se, with a disk-shaped camshaft target that is rigidly mounted on the camshaft. The camshaft target has teeth on its periphery, with the teeth optionally being unevenly distributed. In particular, the teeth can be unevenly spaced apart and/or can be of different lengths (with the length of a tooth corresponding to its angular span along the perimeter of the camshaft target). The camshaft target is thus asymmetric, which allows correct phasing to be achieved, i.e., allowing where each cylinder is placed in the combustion cycle to be determined with certainty. The position of the camshaft target is estimated by the camshaft sensor, which detects times when the teeth pass in front of said camshaft sensor.

In practice, the camshaft sensor generates a signal that assumes a low value in the absence of teeth in front of the sensor, and a high value in the presence of teeth in front of said sensor.

The transition between the low value and the high value of the signal forms a rising edge of the signal, associated with the detection of a rising edge of a tooth of the camshaft target. The transition between the high value and the low value of the signal forms a falling edge of the signal, associated with the detection of a falling edge of a tooth of the camshaft target.

The synchronization methods according to the prior art compare information obtained using the camshaft sensor with information obtained using the crankshaft sensor, so as to determine the position of the engine.

However, the methods are based on recognizing the signature of the crankshaft target, which means that they are ineffective in the event of the failure of the crankshaft sensor or possibly in the event of a significant acceleration.

Another synchronization method is known that overcomes the failure of the crankshaft sensor that is based on identifying the tooth of the camshaft target that is located directly in front of the camshaft sensor, and is described in document FR 2991720, the main steps of which are described hereafter.

This other synchronization method is based on measuring time intervals separating significant edges of the signal generated by the camshaft sensor, and on the use of ratios between several of these measured time intervals.

Each tooth of the camshaft target is denoted by its index i, where i is an integer ranging from 1 to M, with M being the number of teeth on the camshaft target.

A theoretical ratio CP(j), with j ranging from 1 to M, is computed based on known angular deviations P(j) between the tooth edges of the camshaft target, using the following formula:

$$CP ( j ) = {[ \frac{{\sum }_{i = 1}^{N} P ( j - i + 1 ) - {\sum }_{i = 3 N}^{4 N - 1} P ( j - i )}{{\sum }_{i = N}^{3 N - 1} P ( j - i )} ]}_{N \geq 1} \qquad [ Math . 1 ]$$

where P(j) denotes the angular distance between the significant edge j and the preceding edge;
where N is called the computation order of the index. It is an integer greater than or equal to 1. In the simplest scenario, N=1 will be used. In specific cases, N=2 or even N=3 could be used.

For N=1, the expression of CP(j) is simplified to:

$$CP ( j ) = {[ \frac{P ( j ) + P ( j - 3 )}{P ( j - 2 ) + P ( j - 1 )} ]}_{N \geq 1} \qquad [ Math . 2 ]$$

The computing unit is configured to compute time intervals Tk separating two significant edges immediately succeeding each other on said signal.

As soon as this is possible, the following index is computed:

$$CT ( k ) = {[ \frac{{\sum }_{i = 1}^{N} T ( k - i + 1 ) - {\sum }_{i = 3 N}^{4 N - i} T ( k - i )}{{\sum }_{i = N}^{3 N - 1} T ( k - i )} ]}_{N \geq 1} \qquad [ Math . 3 ]$$

where T(k) is the duration of the time interval between the significant edge k and the preceding significant edge.

This involves waiting for 4N+1 edges before the above index can be computed. It is therefore worthwhile selecting the order N=1 in order to be able to compute such an index after 4N intervals between edges, i.e., for the fifth edge when N=1. The index is therefore a ratio of time intervals.

When N is selected as the value N=1, the expression for CT(k) is simplified to:

$$CT ( k ) = {[ \frac{T ( k ) + T ( k - 3 )}{T ( k - 2 ) + T ( k - 1 )} ]}_{N \geq 1} \qquad [ Math . 4 ]$$

CT(k) is thus an actual ratio equivalent to the theoretical ratio CP(j), but based on measurements of time intervals over the signal generated by the camshaft sensor.

In other words, the definition of CT(k) is similar to the definition of the real ratio CP(j), except that the known angular deviations between the significant edges of the teeth of the camshaft target are replaced by time intervals Tk. An uncertainty therefore needs to be tolerated that is represented by a coefficient of uncertainty margin, also called tolerance coefficient Ck.

If the engine rotation speed is constant, then CT(j)=CP(j) for j from 1 to M. In reality, when the engine is running, and in particular during the first few revolutions, the rotation speed is not constant.

In order to take into account the acyclisms of the engine, and/or the variations in acceleration on start-up, the computed index CT(k) is normally compared with each of the features CP(j), and in particular with the intervals INT(j) respectively surrounding each CP(j).

INT(j) corresponds to the following interval:

$$[ \frac{CP ( j )}{Ck} , Ck CP ( j ) ]$$

Following these comparisons, the edges j for which the index CT(k) is outside the interval INT(j) are eliminated from the sub-list.

By repeating the process, it is thus possible to gradually eliminate the hypotheses considered to be unrealistic, until only one plausible value remains for the index of the tooth of the camshaft target currently located facing the sensor.

The ratio Ck must be high enough to withstand significant oscillations when the engine starts, but an excessively high value prevents a reverse rotation from being detected.

Indeed, when the engine changes direction of rotation, the synchronization between two consecutive edges of the camshaft may not represent the correct angular distance, due to the strong deceleration of the engine, and the synchronization may be falsely maintained due to an excessively high ratio factor.

The ratio is therefore difficult to estimate.

This invention proposes a faster method for determining engine synchronization, irrespective of the gear ratio method used (angular or temporal).

The aim of the invention is to overcome the disadvantages of the prior art and notably to reduce the synchronization time in the event of a crankshaft sensor failure.

Indeed, the angular position of the engine is determined from acquiring the determined (known) edge of the crankshaft signal, interpolating the position between the acquisition time and the estimated reception of the next edge. For a 60-2 type target, the angular space is 6° between 2 teeth, and 18° in the signature zone. In degraded mode (i.e., when the crankshaft signal fails), the position is computed based on the acquisition of the known camshaft edge. Similarly, the position is estimated by interpolating the acquisition position, the position of the next edge to arrive, and the elapsed time since the last acquisition.

### DISCLOSURE OF THE INVENTION

To this end, according to a first aspect of the invention, a method is proposed for determining the angular position of a camshaft target rigidly mounted on a camshaft and having a plurality of teeth unevenly angularly distributed around the perimeter of the target, the method being implemented by a computing unit configured to:
acquire a signal generated by a sensor associated with the camshaft target, said sensor being configured to detect the passage of the teeth of the camshaft target and in response to generate a signal comprising rising edges and falling edges respectively associated with rising edges or falling edges of said teeth;
the plurality of teeth forming, for the sensor, a series of significant edges when the camshaft rotates one revolution, with each significant edge being associated with a predetermined index for the identification thereof; and
compute the time intervals separating two significant edges immediately succeeding each other on said signal;
store, for each edge j of the M significant edges:
a theoretical ratio CP(j), with j ranging from 1 to M, determined based on known angular deviations P(j) between known significant edges of the camshaft target;
an associated tolerance interval INT(j), depending on the value assumed by the theoretical ratio CP(j) and a tolerance factor Ck;
an associated confidence interval INTC(j), depending on the value assumed by the theoretical ratio CP(j) and a confidence factor Cc, with the confidence factor being less than the tolerance factor Ck;
associate a suspicion meter S(j) and set it to a zero value;
the computing unit is also configured to:
/a/ define a list of candidate edges made up of all the significant edges;
/b/ determine a current value assumed by a real ratio CT(k) depending on a first set of time intervals Tk, where the definition of the real ratio CT(k) is similar to the definition of the theoretical ratio CP(j) except that the known angular deviations are replaced by the corresponding time intervals Tk between the significant edges;
/c/ implement a discrimination step, comprising, for each edge j in the list of candidate edges:
   if the current value assumed by the real ratio CT(k) does not belong to the tolerance interval INT(j) associated with said edge j: deleting said edge j from the list of candidate edges, with the suspicion meter S(j) then being assigned a predetermined value, called maximum value;
   otherwise, if the current value assumed by the real ratio CT(k) is outside the confidence interval INTC(j) associated with said edge: incrementing the current value of the suspicion meter S(j) associated with said edge in the list, then removing said edge j from the list of candidate edges when the suspicion meter is greater than the maximum value;
/d/ wait for the reception of a new significant edge, replace each edge j in the list with its immediate successor j+1 modulo M, then repeat steps /b/ and /c/ until a single candidate edge is obtained in the list of significant edges;
the angular position of the camshaft target is then determined based on the angular position of the single significant edge in the list of candidate edges.

In an advantageous embodiment, during step /d/ , steps /b/ and /c/ are repeated until a single candidate edge is obtained in the list of significant edges or there is a single candidate edge in the list of significant edges with a suspicion meter with a zero value. This second condition allows faster convergence.

Preferably, for each of the M significant edges, the theoretical ratios CP(j), with j ranging from 1 to M, are defined by:

$$CP ( j ) = {[ \frac{{\sum }_{i = 1}^{N} P ( j - i + 1 ) - {\sum }_{i = 3 N}^{4 N - 1} P ( j - i )}{{\sum }_{i = N}^{3 N - 1} P ( j - i )} ]}_{N \geq 1} \qquad [ Math . 5 ]$$

where P(j) denotes the angular distance between the significant edge j and the preceding edge;
where N is an integer greater than or equal to 1, called the computation order of the index;
and the real ratio CT(k), with k ranging from 1 to M, is defined by:

$$CT ( k ) = {[ \frac{{\sum }_{i = 1}^{N} T ( k - i + 1 ) - {\sum }_{i = 3 N}^{4 N - 1} T ( k - i )}{{\sum }_{i = N}^{3 N - 1} T ( k - i )} ]}_{N \geq 1} \qquad [ Math . 6 ]$$

where T(k) is the duration of the time interval between the significant edge k and the preceding significant edge.

Advantageously, N=1, with the expressions of CP(j) and CT(k) becoming:

$$CP ( j ) = {[ \frac{P ( j ) + P ( j - 3 )}{P ( j - 2 ) + P ( j - 1 )} ]}_{N \geq 1} \qquad [ Math . 7 ]$$

$$and$$

$$CT ( k ) = {[ \frac{T ( k ) + T ( k - 3 )}{T ( k - 2 ) + T ( k - 1 )} ]}_{N \geq 1} \qquad [ Math . 8 ]$$

The tolerance factor Ck can be selected so as to be greater than or equal to 2.1.

The confidence factor Cc is preferably less than or equal to 1.8.

Advantageously, the significant edges immediately succeeding each other are rising or falling edges.

According to one aspect of the invention, a computer program is proposed comprising program code instructions for executing the steps of the synchronization method according to the first aspect of the invention, when said program runs on a computer.

According to yet another aspect of the invention, a module is proposed for determining the angular position of a camshaft target rigidly mounted on a camshaft and having a plurality of teeth unevenly angularly distributed around the perimeter of the target, comprising a computing unit configured to:
acquire a signal generated by a sensor associated with the camshaft target, said sensor being configured to detect the passage of the teeth of the camshaft target and in response to generate a signal comprising rising edges and falling edges respectively associated with rising edges or falling edges of said teeth;
the plurality of teeth forming, for the sensor, a series of M significant edges when the camshaft rotates one revolution, with each significant edge being associated with a predetermined index for the identification thereof; and
compute the time intervals separating two significant edges of a series of M significant edges immediately succeeding each other on said signal;
store, for each of the M significant edges:
a theoretical ratio CP(j), with j ranging from 1 to M, determined based on known angular deviations P(j) between known significant edges of the teeth of the camshaft target;
an associated tolerance interval INT(j), depending on the value assumed by the theoretical ratio CP(j) and a tolerance factor Ck;
an associated confidence interval INTC(j), depending on the value assumed by the theoretical ratio CP(j) and a confidence factor Cc, with the confidence factor being less than the tolerance factor Ck;
associate a suspicion meter S(j) and set it to a zero value;
the computing unit is also configured to:
/a/ define a sub-list of significant edges made up of all the significant edges;
/b/ determine a current value assumed by a real ratio CT(k) depending on a first set of time intervals Tk, where the definition of the real ratio CT(k) is similar to the definition of the theoretical ratio CP(j) except that the known angular deviations are replaced by the corresponding time intervals Tk between the significant edges of the teeth of the camshaft target;
/c/ discriminate, for each edge j in the list of candidate edges:
   if the current value assumed by the real ratio CT(k) does not belong to the tolerance interval INT(j) associated with said edge j: deleting said edge j from the list of candidate edges; then,
   otherwise, if the current value assumed by the real ratio CT(k) is outside the confidence interval INTC(j) associated with said edge: incrementing the current value of the suspicion meter S(j) associated with said edge in the list, then removing said edge j from the list of candidate edges when the suspicion meter is greater than the maximum value;
/d/ wait for the reception of a new significant edge, replace each edge j in the list with its immediate successor j+1 modulo M, then repeat steps /b/ and /c/ until a single candidate edge is obtained in the list of significant edges;
determine the angular position of the camshaft target based on the angular position of the single significant edge in the list of candidate edges.

According to another aspect of the invention, a motor vehicle is proposed comprising a module according to the invention.

### BRIEF DESCRIPTION OF THE FIGURES

Further features and advantages of the invention will become apparent upon reading the following detailed description, which will be more clearly understood with reference to the appended drawings, in which:

FIG. 1 illustrates an embodiment of a module according to the invention and its physical environment; and

FIG. 2 illustrates an embodiment of a method according to the invention;

FIG. 3 illustrates intervals used in the method of FIG. 2.

### DETAILED DESCRIPTION OF THE INVENTION

With reference to the figures, an embodiment of a method P for determining the angular position of a camshaft target C of a vehicle engine will now be described, together with a module for determining the angular position and a vehicle equipped with said module.

The camshaft target C is rigidly mounted on a camshaft A and has a plurality of teeth evenly distributed around the perimeter of the camshaft. A target comprising a plurality of evenly angularly distributed teeth, with the exception of one or more specific areas, is a target with unevenly distributed teeth. This is the case, for example, for a target with 60 evenly distributed teeth, except for an area where one or two teeth are missing. In other words, a target with an even distribution and one or more irregularities is a target with a plurality of unevenly distributed teeth.

The sensor S is typically associated with the target C rotatably rigidly mounted on the camshaft A.

The camshaft target C has a plurality of teeth unevenly distributed around the perimeter of the camshaft A, with each tooth being associated with a predetermined index for the identification thereof.

The sensor S is configured to detect the passage of the teeth of the camshaft target C and in response to generate a signal comprising rising edges and falling edges respectively associated with rising edges and falling edges of said teeth. Such a signal is shown in the following figures.

The computing unit Uc is configured to acquire a signal generated by the camshaft sensor S.

For the remainder of the description, the notion of a significant edge is introduced. A significant edge is a type of edge that is processed by the identification logic implemented in the computing unit Uc. For some types of camshaft target, the significant edges are the rising and falling edges, whereas for other types of camshaft target, only the rising or falling edges are significant. For some targets, the immediately succeeding significant edges are falling edges.

The number of significant edges in one revolution of the camshaft target is noted M hereafter.

The computing unit Uc is also configured to compute time intervals Tk separating two immediately succeeding significant edges on the signal.

### Theoretical Ratios

The computing unit is also configured to store, for each of the M significant edges, a theoretical ratio CP(j), with j ranging from 1 to M, determined based on known angular deviations P(j) between known significant edges of the teeth of the camshaft target.

As in the prior art, the theoretical ratios CP(j), with j ranging from 1 to M, can be defined by:

$$CP ( j ) = {[ \frac{{\sum }_{i = 1}^{N} P ( j - i + 1 ) - {\sum }_{i = 3 N}^{4 N - 1} P ( j - i )}{{\sum }_{í = N}^{3 N - 1} P ( j - i ) )} ]}_{N \geq 1} \qquad [ Math . 9 ]$$

where P(j) denotes the angular distance between the significant edge j and the preceding edge;
where N is an integer greater than or equal to 1, called the computation order of the index.

Preferably, N=1, and the expression CP(j) becomes:

$$CP ( j ) = {[ \frac{P ( j ) + P ( j - 3 )}{P ( j - 2 ) + P ( j - 1 )} ]}_{N \geq 1} \qquad [ Math . 10 ]$$

However, other theoretical ratios can be used.

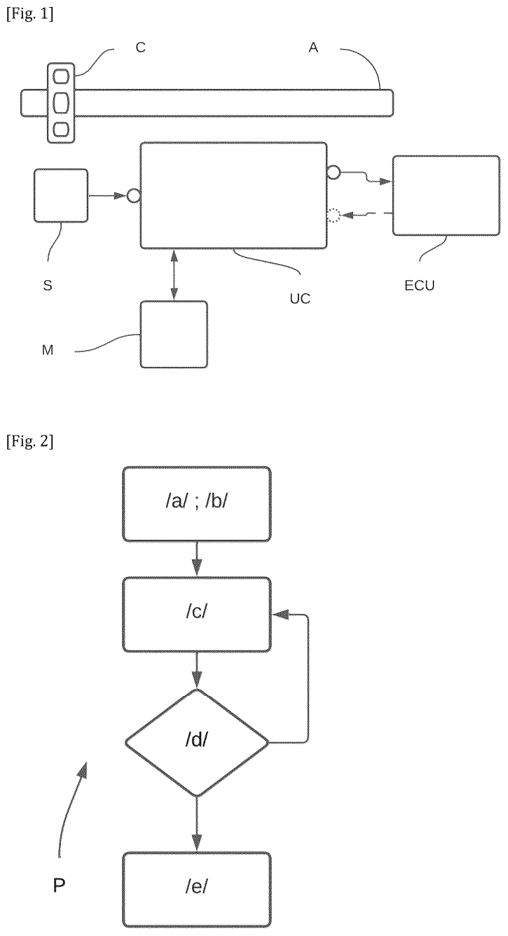

With reference to FIG. 2, the computing unit is also configured to:
/a/ define a list of candidate edges made up of all the significant edges;
/b/ determine a current value assumed by a real ratio CT(k) depending on a first set of time intervals Tk, where the definition of the real ratio CT(k) is similar to the definition of the theoretical ratio CP(j) except that the known angular deviations are replaced by the corresponding time intervals Tk between the significant edges;
/c/ discriminate, for each edge j in the list of candidate edges:
   if the current value assumed by the real ratio CT(k) does not belong to the tolerance interval INT(j) associated with said edge j: deleting said edge j from the list of candidate edges; then,
   otherwise, if the current value assumed by the real ratio CT(k) belongs to the confidence interval INTC(j) associated with said edge: resetting the suspicion meter S(j) to a zero value when j; then
   otherwise: incrementing the current value of the suspicion meter S(j) associated with said edge in the list, then deleting said edge j from the list of candidate edges when the suspicion meter is greater than a predetermined number;
/d/ wait for the reception of a new significant edge, replace each edge j in the list with its immediate successor j+1 modulo M, then repeat steps /b/ and /c/ until a single candidate edge is obtained in the list of significant edges;
the angular position of the camshaft target is then determined based on the angular position of the single significant edge in the list of candidate edges.

Preferably, each interval INT(j) is delimited by a lower limit and an upper limit, with:
the lower limit being equal to the quotient of the value assumed by the theoretical ratio CP(j) divided by a tolerance factor Ck; and
the upper limit being equal to the product of the value assumed by the theoretical ratio CP(j) multiplied by the tolerance factor Ck.

The tolerance interval INT (j) is defined by a lower limit V_{low} and an upper limit Vᵤₚₚ, with V_{low}=CP(j)/Ck and Vᵤₚₚ=CP(j)*Ck.

Preferably, the confidence interval INTC(j) is delimited by a lower limit and an upper limit, with:
the lower limit being equal to the quotient of the value assumed by the theoretical ratio CP(j) divided by a confidence factor Cc; and
the upper limit being equal to the product of the value assumed by the theoretical ratio CP(j) multiplied by the confidence factor Cc.

The confidence interval INTC(j) is defined by a lower limit V_{lowC} and an upper limit V_{uppC}, with V_{lowC}=CP(k)/Cc and V_{uppC}=CP(k)*Cc.

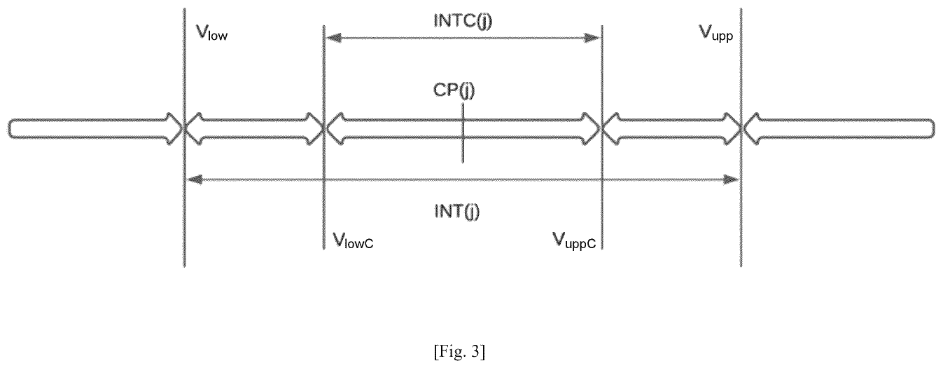

FIG. 3 illustrates confidence intervals INTC(j) and tolerance intervals INT(j) centered around a theoretical ratio CP(j), with the interval INTC(j) being within the interval INT(j).

The interval INTC(j) is delimited by the lower limit V_{infC} and the upper limit V_{uppC}, with the interval INT(j) being delimited by the lower limit V_{low} and the upper limit Vᵤₚₚ.

According to one possibility, step /d/ can further comprise an additional condition for stopping iterations of steps /b/ and /c/ and then transitioning to step /e/ , with the additional condition being that there is only one candidate edge in the list of significant edges with a suspicion meter with a zero value.

As in the prior art, the real ratios CT(k), with k ranging from 1 to M, can be defined by:

$$CT ( k ) = {[ \frac{{\sum }_{i = 1}^{N} T ( k - i + 1 ) - {\sum }_{i = 3 N}^{4 N - 1} T ( k - i )}{{\sum }_{í = N}^{3 N - 1} T ( k - i )} ]}_{N \geq 1} \qquad [ Math . 11 ]$$

where T(k) is the duration of the time interval between the significant edge k and the preceding significant edge.

Preferably, N=1, and the expression CP(j) becomes:

$$CT ( k ) = {[ \frac{T ( k ) + T ( k - 3 )}{T ( k - 2 ) + T ( k - 1 )} ]}_{N \geq 1} \qquad [ Math . 12 ]$$

Preferably, the tolerance factor Ck is greater than or equal to 2.1, or even greater than or equal to 2.5 or even greater than or equal to 2.8.

Preferably, the confidence factor is less than or equal to 1.8.

The module M according to the invention can be implemented in the form of an electronic module comprising a memory storing a computer program product comprising instructions intended to be executed by the computing unit UC or by the engine control unit ECU, which then replaces the computing unit UC.

Of course, the invention is not limited to the examples that have been described above, and these examples can be adapted in numerous ways without departing from the scope of the invention. Furthermore, the various features, forms, variants and embodiments of the invention can be combined with one another in various combinations provided they are not incompatible or mutually exclusive.

1. A method (M) for determining the angular position of a camshaft target (C) rigidly mounted on a camshaft (A) and having a plurality of teeth unevenly angularly distributed around the perimeter of the target, the method being implemented by a computing unit (CU) configured to:
acquire a signal generated by a sensor (S) associated with the camshaft target, said sensor being configured to detect the passage of the teeth of the camshaft target and in response to generate a signal comprising rising edges and falling edges respectively associated with rising edges or falling edges of said teeth;
the plurality of teeth forming, for the sensor, a series of M significant edges when the camshaft rotates one revolution, with each significant edge being associated with a predetermined index for the identification thereof; and
compute the time intervals separating two significant edges immediately succeeding each other on said signal;
store, for each edge j of the M significant edges:
a theoretical ratio CP(j), with j ranging from 1 to M, determined based on known angular deviations P(j) between known significant edges of the camshaft target;
an associated tolerance interval INT(j), depending on the value assumed by the theoretical ratio CP(j) and a tolerance factor Ck;
an associated confidence interval INTC(j), depending on the value assumed by the theoretical ratio CP(j) and a confidence factor Cc, with the confidence factor Cc being less than the tolerance factor Ck;
associate a suspicion meter SU) and set it to a zero value;
the computing unit is also configured to:
/a/ define a list of candidate edges made up of all the significant edges;
/b/ determine a current value assumed by a real ratio CT(k) depending on a first set of time intervals Tk, where the definition of the real ratio CT(k) is similar to the definition of the theoretical ratio CP(j) except that the known angular deviations are replaced by the corresponding time intervals Tk between the significant edges;
/c/ implement a discrimination step, comprising,
for each edge j in the list of candidate edges:
if the current value assumed by the real ratio CT(k) does not belong to the tolerance interval INTO) associated with said edge j: deleting said edge j from the list of candidate edges, with the suspicion meter S(j) then being assigned a predetermined value, called maximum value; then,
otherwise, if the current value assumed by the real ratio CT(k) is outside the confidence interval INTC(j) associated with said edge: incrementing the current value of the suspicion meter S(j) associated with said edge in the list, then removing said edge j from the list of candidate edges when the suspicion meter is greater than the maximum value;
/d/ wait for the reception of a new significant edge, replace each edge j in the list with its immediate successor j+1 modulo M, then repeat steps /b/ and /c/ until a single candidate edge is obtained in the list of significant edges;
/e/ the angular position of the camshaft target is then determined based on the angular position of the single significant edge in the list of candidate edges.

2. The method as claimed in claim 1, wherein, during step /d/ , steps /b/ and /c/ are repeated until a single candidate edge is obtained in the list of significant edges or there is a single candidate edge in the list of significant edges with a suspicion meter with a zero value.

3. The method as claimed in claim 2, wherein, for each of the M significant edges, the theoretical ratios CP(j), with j ranging from 1 to M, are defined by:
$$CP ( j ) = {[ \frac{{\sum }_{i = 1}^{N} P ( j - i + 1 ) - {\sum }_{í = 3 N}^{4 N - 1} P ( j - i )}{{\sum }_{i = N}^{3 N - 1} P ( j - i )} ]}_{N \geq 1} \qquad [ Math . 13 ]$$
where P(j) denotes the angular distance between the significant edge j and the preceding edge;
where N is an integer greater than or equal to 1, called the computation order of the index;
and the real ratio CT(k), with k ranging from 1 to M, is defined by:
$$T ( k ) = {[ \frac{{\sum }_{i = 1}^{N} T ( k - i + 1 ) - {\sum }_{i = 3 N}^{4 N - 1} T ( k - i )}{{\sum }_{i = N}^{3 N - 1} T ( k - i )} ]}_{N \geq 1} \qquad [ Math . 14 ]$$
where T(k) is the duration of the time interval between the significant edge k and the preceding significant edge.

4. The method as claimed in claim 3, wherein N=1, with the expressions of CP(j) and CT(k) becoming:
$$CP ( j ) = {[ \frac{P ( j ) + P ( j - 3 )}{P ( j - 2 ) + P ( j - 1 )} ]}_{N \geq 1} \qquad [ Math . 15 ]$$
$$and$$
$$CT ( k ) = {[ \frac{T ( k ) + T ( k - 3 )}{T ( k - 2 ) + T ( k - 1 )} ]}_{N \geq 1} \qquad [ Math . 16 ]$$

5. The method as claimed in claim 4, wherein the tolerance factor is greater than or equal to 2.1.

6. The method as claimed in claim 5, wherein the confidence factor is less than or equal to 1.8.

7. The method as claimed in claim 1, wherein the significant edges immediately succeeding each other are falling or rising edges.

8. A computer program comprising program code instructions for executing the steps of the synchronization method as claimed in claim 1, when said program runs on a computer.

9. A module (M) for determining the angular position of a camshaft target (C) rigidly mounted on a camshaft (A) and having a plurality of teeth unevenly angularly distributed around the perimeter of the target, comprising a computing unit (CU) configured to:
acquire a signal generated by a sensor (S) associated with the camshaft target, said sensor being configured to detect the passage of the teeth of the camshaft target and in response to generate a signal comprising rising edges and falling edges respectively associated with rising edges or falling edges of said teeth;
the plurality of teeth forming, for the sensor, a series of M significant edges when the camshaft rotates one revolution, with each significant edge being associated with a predetermined index for the identification thereof; and
compute the time intervals separating two significant edges of a series of M significant edges immediately succeeding each other on said signal;
store, for each of the M significant edges:
a theoretical ratio CP(j), with j ranging from 1 to M, determined based on known angular deviations P(j) between known significant edges of the teeth of the camshaft target;
an associated tolerance interval INT(j), depending on the value assumed by the theoretical ratio CP(j) and a tolerance factor Ck;
an associated confidence interval INTC(j), depending on the value assumed by the theoretical ratio CP(j) and a confidence factor Cc, with the confidence factor Cc being less than the tolerance factor Ck;
associate a suspicion meter SU) and set it to a zero value;
the computing unit is also configured to:
/a/ define a sub-list of significant edges made up of all the significant edges;
/b/ determine a current value assumed by a real ratio CT(k) depending on a first set of time intervals Tk, where the definition of the real ratio CT(k) is similar to the definition of the theoretical ratio CP(j) except that the known angular deviations are replaced by the corresponding time intervals Tk between the significant edges of the teeth of the camshaft target;
/c/ discriminate, for each edge j in the list of candidate edges:
if the current value assumed by the real ratio CT(k) does not belong to the tolerance interval INT(j) associated with said edge j: deleting said edge j from the list of candidate edges, with the suspicion meter S(j) then being assigned a predetermined value, called maximum value; then,
otherwise, if the current value assumed by the real ratio CT(k) is outside the confidence interval INTC(j) associated with said edge: incrementing the current value of the suspicion meter S(j) associated with said edge in the list, then removing said edge j from the list of candidate edges when the suspicion meter is greater than the maximum value;
/d/ wait for the reception of a new significant edge, replace each edge j in the list with its immediate successor j+1 modulo M, then repeat steps /b/ and /c/ until a single candidate edge is obtained in the list of significant edges;
/e/ determine the angular position of the camshaft target based on the angular position of the single significant edge in the list of candidate edges.

10. A motor vehicle comprising a module as claimed in claim 9.
